(19) United States
(12) Patent Application Publication
(10) Pub. No.: US 2004/0162734 A1
(43) Pub. Date: Aug. 19, 2004

(54) Method for financing the purchase of lawn care equipment and services

(76) Inventors: Kenneth Speece, Wooster, OH (US); Anthony Williams, Canton, OH (US); Mark Kluck, Strongsville, OH (US)

Correspondence Address: Daniel A. Thomson, Brouse McDowell, 500 First National Tower, 106 S. Main Street, Akron, OH, 44308-1471, US

(21) Appl. No.: 10/368,210

(22) Filed: Feb. 17, 2003

(51) Int. Cl. G06F 17/60

(52) U.S. Cl. 705/1

(57) ABSTRACT

A method for financing the purchase of outdoor equipment in conjunction with the purchase and financing of real estate is provided. A lending entity provides a mortgage loan amount to finance the real estate, and the purchase price of an item of outdoor equipment for maintaining the property is included in the mortgage loan amount.

### BACKGROUND OF THE INVENTION

1. Field of Invention

This invention pertains to the art of methods for selling and purchasing outdoor lawn equipment, especially as related to outdoor maintenance equipment and more specifically to financing the outdoor equipment by incorporating the purchase price of the outdoor equipment into the mortgage loan for a real estate purchase.

2. Description of the Related Art

It is known to provide financing for the purchase of new and existing homes. It is also known to provide financing through some dealers of lawn care equipment, such as Cub Cadet dealerships. However, the inventors believe it is not known to provide financing for lawn care equipment in conjunction with the purchase of a new home or other property.

It is common for purchasers of new or existing homes to upgrade their situation by buying larger homes on larger lots. For example, one very common and likely scenario is for a couple to first marry and then rent an apartment. The lawn care around the apartment would be minimal and would be performed by the owner of the rental property. As the years went by, the couple might decide to have a family, and would desire a larger home with a yard so that the children could play. This would necessitate the purchase of a home having a lawn. Usually, when a first time home purchaser purchases their home, they tend to take nearly all of their money and provide it to the bank as a payment for the loan transaction fee and for the down payment to purchase a property. As such, immediately after the purchase of the new home, the purchaser is cash-strapped and unable to purchase other immediate necessary home items, at least for a while. This comes at a very unfortunate time, as the homeowners probably want to buy products for the inside of their home as well, such as new draperies, carpets, and the like. As such, the need for appropriate lawn care equipment such as tractors, lawn mowers, string trimmers, edgers, sprinkling and irrigation systems, lighting systems, and the like are deferred. This creates undesirable situations. First, the grass will continue to grow, whether or not the homeowner has enough money to purchase the right lawn mower. Secondly, the value of the real estate just purchased depends greatly on the lawn itself and its appearance. It is unfortunate that, immediately after making this major investment, the homeowner is unable to maintain the quality and appearance of his real estate investment. When faced with this situation, many consumers survive by delaying the purchase of the lawn care equipment by signing up with a lawn care service or by purchasing used or less desirable equipment as a stop gap measure until the homeowner has enough cash to purchase the equipment he really wants.

Another problem, or financial opportunity, identified by the inventors is the fact that purchasing quality real estate is easier because of the availability of financing from banks as well as the deductibility of such financing on ones federal tax return. The availability of such financing enables many people to afford to buy their own home.

The problem presented by the above situations is that, at a time when the homeowner is more cash strapped and unable to make purchases, is when the need for such purchases arises. Lawn and garden tractors, edgers, and string trimmers represent a significant financial investment if one does not already own such equipment. At the same time, the grass will keep growing and the homeowner cannot wait two, three, or four years until he has enough money to purchase such equipment. The real estate investment purchased by the homeowner at considerable cost and risk, is incrementally degrading and the value of the investment is eroding due to the inability of the homeowner to purchase proper maintenance equipment.

The inventors have identified this problem and have invented a novel and effective way to address these problems. The invention involves the association of various entities previously not associated in this manner; to provide financing, distribution, and installation of the required lawn care equipment in a manner and method enabling the homeowner to afford it.

### SUMMARY OF THE INVENTION

It is an object of the invention to provide a new method of financing purchases of lawn care equipment to purchasers of new and existing homes.

It is also an object of this invention to provide such financing in a method that is easy for the consumer to purchase greater amounts of lawn care equipment than they would normally be able to do.

It is an object of this invention to provide a financial mechanism whereby the purchaser of a new or existing home with a different lot than their previous home, has the wherewithal to purchase the appropriate equipment necessary to maintain the value of his investment.

It is an object of this invention to provide a method whereby a purchaser of a new or existing home has the ability to purchase necessary equipment to maintain his investment in the new home and lawn at a time when the purchaser has less available cash than at other times.

In accordance with one aspect of the present invention, a method of financing the purchase of outdoor power equipment in conjunction with the purchase and financing of an associated piece of real estate comprises providing a mortgage loan amount for the associated piece of real estate, providing at least a first associated item of outdoor equipment, the item having an associated purchase price, and including the associated purchase price of the at least a first associated item of outdoor equipment in the mortgage loan amount.

In accordance with another aspect of the present invention, the method further includes providing an associated lending entity to provide the mortgage loan amount and providing an associated supplier of the at least a first associated item of outdoor equipment.

In accordance with another aspect of the present invention, the method further includes providing at least a first associated item of outdoor power equipment, the item having an associated purchase price.

In accordance with another aspect of the present invention, the mortgage loan amount has an associated interest rate.

In accordance with another aspect of the present invention, the associated supplier and the associated lender entity are separate entities.

In accordance with another aspect of the present invention, the method further includes applying a mortgage lien to the associated first item of outdoor equipment.

In accordance with another aspect of the present invention, the method further includes providing a lending entity to provide the mortgage loan amount and providing a supplier of the outdoor power equipment, the lending entity receiving a commission from the supplier based upon the sale of the outdoor power equipment.

In accordance with another aspect of the present invention, the method further includes providing a lending entity to provide the mortgage loan amount and providing a supplier of the outdoor power equipment, the supplier receiving a commission from the lending entity based upon the recommendation by the supplier that an associated purchase utilize the lending entity for the mortgage loan.

In accordance with another aspect of the present invention, a method of selling associated outdoor equipment for use in maintaining an associated item of real estate includes providing a an associated item of real estate, providing at least a first item of outdoor equipment for use in maintaining the associated item of real estate, providing a mortgage loan for the purchase of the associated item real estate and the at least a first item of outdoor equipment, and providing a voucher for use in purchasing the at least a first item of outdoor equipment.

In accordance with another aspect of the present invention, the method further includes providing a supplier to supply the at least a fist item of outdoor equipment, the supplier accepting the voucher for purchase of the at least a first item of outdoor equipment.

In accordance with another aspect of the present invention, the method further includes applying a mortgage lien to the associated at least a first item of outdoor equipment.

In accordance with another aspect of the present invention, the associated at least a first item of outdoor equipment is chosen from the fertilizer spreaders, outdoor lighting, motion sensors, power tools, power blowers, air sweepers for lawn debris, power operated, tractor-towed impellers, lifts, tillers, cultivators, plows, vacuums, blowers, lawn sweepers, mulchers, riding mowers, walk-behind mowers, self-propelled mowers, side discharged mowers, convertible lawn mowers, rear discharge mowers, side-discharge high-wheel mowers, mulching mowers, electric mowers, chipper/shredders, front tine tillers, rear tine tillers, self-propelled tillers, edgers, snow throwers, track driver snow throwers, log splitters, commercial lawn mowers, riding sulkies, seated sulkies for lawn mowers, multi-purpose vacuum cleaners, lawn and garden tractors, and three-point tractor hitches.

In accordance with another aspect of the present invention, the method further includes providing a building contractor to facilitate the construction of the real estate property.

In accordance with another aspect of the present invention, the method further includes a percentage rate of the loan f to purchase the real estate is the same percentage rate of the loan for lending money to purchase the outdoor equipment and wherein the terms of the loan for the real estate is the same as the terms for the outdoor equipment.

In accordance with another aspect of the present invention, a computer readable medium containing instructions for controlling a computer system to perform a method including providing a mortgage loan amount for the associated piece of real estate, providing at least a first associated item of outdoor equipment, the item having an associated purchase price, including the associated purchase price of the at least a first associated item of outdoor equipment in the mortgage loan amount, providing an associated lending entity to provide the mortgage loan amount, providing an associated supplier of the at least a first associated item of outdoor equipment, wherein the mortgage loan amount has an associated interest rate, applying a mortgage lien to the associated first item of outdoor equipment, providing a lending entity to provide the mortgage loan amount, providing a supplier of the outdoor power equipment, the lending entity receiving a commission from the supplier based upon the sale of the outdoor power equipment, alternatively, the supplier receiving a commission from the lending entity based upon the recommendation by the supplier that an associated purchase utilize the lending entity for the mortgage loan.

Still other benefits and advantages of the invention will become apparent to those skilled in the art to which it pertains upon a reading and understanding of the following detailed specification.

### DETAILED DESCRIPTION OF THE INVENTION

There is provided a purchaser desirous purchasing a parcel of real estate or property. In this embodiment, the real estate or property may include a preexisting structure or building located on a parcel of land. The building may be a house to be used by the purchaser for residential purposes, as rental property, or any other use chosen with sound business and financial judgment. However, it is noted that any type of building or structure may preexist including buildings for use by businesses, as well as individuals. The purchaser has a need as previously discussed to maintain the property and/or the building located on the parcel of land. Maintenance of the property may include cutting and edging the lawn, dispensing chemicals to maintain the turf such as fertilizer and weed killers, snow removal, pruning of trees and other foliage, and the like. Maintaining the property may also include the installation of outdoor lighting, motion sensors, and the like. Maintaining the property requires outdoor equipment that may include fertilizer spreaders, outdoor lighting, motion sensors, power tools, power blowers, air sweepers for lawn debris, power operated, tractor-towed impellers, lifts, tillers, cultivators, plows, vacuums, blowers, lawn sweepers, mulchers, riding mowers, walk-behind mowers, self-propelled mowers, side discharged mowers, convertible lawn mowers, rear discharge mowers, side-discharge high-wheel mowers, mulching mowers, electric mowers, chipper/shredders, front tine tillers, rear tine tillers, self-propelled tillers, edgers, snow throwers, track driver snow throwers, log splitters, commercial lawn mowers, riding sulkies, seated sulkies for lawn mowers, multi-purpose vacuum cleaners, lawn and garden tractors, and three-point tractor hitches, and the like. However, any outdoor equipment or tools may used to maintain, beautify, protect, or keep up the property as chosen with sound judgment that pertains to the present invention.

With continued reference to the invention, the purchaser may contact a lending entity for financing the purchase. It is expressly noted that any entity capable of loaning money sufficient for the purchase of the items as described in the present application may be considered as a lending entity. This may include banks, savings and loan institutions, builders, contractors, or other parties. There is also provided a supplier of the outdoor equipment, which may have an agreement with the lending entity, as will be subsequently discussed. The supplier of the outdoor equipment may be a manufacturer of the outdoor equipment, a reseller of the outdoor equipment, a retail establishment, an authorized dealer of the manufacturer, or any type of distributor. The supplier may agree with the lending entity to offer the outdoor equipment for sale, through the lending entity, wherein outdoor equipment is financed by the lending entity in conjunction with financing of property.

Contracting with the lending entity by the supplier may include incentives for either party for the selling of the outdoor equipment and/or the financing thereof. For example, the lending entity may receive commissions from the supplier based on the sale of outdoor equipment. It is to be understood that “commissions” is intended to have as broad a definition as possible, and is intended to include any monetary or non-monetary compensation between the parties related to the sale of the outdoor equipment. Similarly, the supplier may receive commissions from the lending entity for recommending that the purchaser finance the outdoor equipment through the lending entity. However, it is expressly stated that each party, the lending entity or the supplier, may receive the inherent benefits of increased business from a business relationship such as is described herein. It is to be understood that the commissions are not intended to limit the invention in any manner, and are merely one embodiment of this invention. In this manner, the lending entity, or the supplier, at any stage of the financing process may suggest that the purchaser purchase and finance outdoor equipment in conjunction with the purchase of the property.

In another embodiment of the present invention, the purchase and financing of the outdoor equipment may include vouchers, for a predetermined amount, presented to the purchaser for use at an associated selling establishment for the selective purchase of outdoor equipment.

With continued reference to the invention, a description of the details and method for financing outdoor equipment will now be described. A lending entity may agree with a supplier to provide financing for outdoor equipment supplied by the supplier in conjunction with the purchase and financing of property. A purchaser may select a property for purchase that requires maintenance in a manner as previously described. The property may include a house, or other structure, along with associated land. The purchaser may approach the lending entity to apply for a loan sufficient to purchase the property. It is to be noted that the lending entity, having knowledge that the purchaser is interested in a loan, may approach the purchaser first. The lending entity may propose that the purchaser consider purchasing outdoor equipment to maintain the property and that the financing of the outdoor equipment may be incorporated into the loan for the purchase of the property. The purchaser may then select specific articles of outdoor equipment for purchase or may just decide upon a predetermined amount for purchasing outdoor equipment at a later time.

For example, the purchaser may decide to borrow an amount for use exclusively in acquiring whatever outdoor equipment is desired. In this manner, the purchaser may decide to wait for seasonal equipment to be offered for sale or may decide to wait until the outdoor equipment is offered at a discounted price. The purchaser would then apply for the loan for the total amount of both the property and the outdoor equipment. The lending entity would then process the loan. Upon approval and/or closing of the loan, the lending entity may provide a voucher to the purchaser for the previously determined amount for selecting and purchasing the outdoor equipment at any desired time. The purchaser may then proceed to the supplier for selection of the specific articles of outdoor equipment.

It is also noted that the purchaser may select the specific articles of outdoor equipment for purchase at the time of applying for the loan with the lending entity. In this instance, the lending entity may inform the supplier of the selected articles of outdoor equipment desired and provide payment for the outdoor equipment to the supplier. Any manner of arranging for delivery or pick up of the purchased outdoor equipment may be chosen, as long as chosen using sound business and financial judgment. In this manner, the lending entity would facilitate the purchase of the outdoor equipment with the supplier on behalf of the purchaser. Referring again to offering the financing of outdoor equipment with the purchase of property, any manner of presenting the outdoor equipment to the purchaser for purchase may be chosen. This may include brochures, electronic catalogs, or images viewed over the Internet. However, any manner of showing what outdoor equipment is for sale may be chosen. The purchaser may also have visited the supplier at any time before or during the financing process for selecting desired articles of outdoor equipment.

Subsequent to the approval of the loan and the closing thereof, the purchaser may take possession of the property and the outdoor equipment. It is expressly noted that the timing or order of taking possession of the property and the outdoor equipment is not critical to the method of the present invention. Finally, it is to be understood that the details of financing the purchase of property is well known in the art and no further explanation will be provided at this point.

With continued reference to the invention, it is contemplated in an alternate embodiment that the purchaser may visit the supplier before applying for a loan for the purchase of property. In this instance, the supplier may suggest to the purchaser that the lending entity, with whom the supplier is associated and as previously described, may offer financing for the purchase of both the outdoor equipment of the supplier and any desired property. In this manner, the supplier may initiate the process of financing property in conjunction with outdoor equipment. A builder might, for example, say that this new home purchase came with an MTD® 16 hp Yard Man® tractor with a mulching unit. In addition, the purchase of the home included a Ryobi® 4 cycle gas-powered string trimmer an MTD® edger and a 10 hp self-propelled Troy-Bilt® snow thrower. If the homeowner wanted to upgrade any of these items to a larger horsepower engine, the homebuilder would present the home purchaser with a voucher redeemable at the showroom of the manufacturer of the lawn and garden equipment.

In another embodiment of the invention, the homebuilder, or the building association, would contract with a particular supplier, such as Lowe's®. In this case, as part of the purchase of the property, the homeowner would receive a voucher redeemable at Lowe's® for various products, including lawn and garden products.

In another embodiment, a contractor or builder facilitates or manages the construction of a new building on a parcel of land. The builder may contract with the supplier to offer for sale, and the financing thereof, of outdoor equipment with the construction of the new building. Typically, such builders have a budget for certain aspects of a home such as wallpaper, cabinetry, and electrical appliances. For example, in the case of electrical appliances, a typical situation would be for the homeowner to purchase a home for a certain price, for example $150,000. As a part of that purchase price, the builder is willing to provide a washer, a dryer, a dishwasher, and an air-conditioner for a total aggregate amount of, for example, $4,000. If a homeowner, however, would like to upgrade and buy more expensive appliances, the builder provides to the homeowner a voucher, which is redeemable at the showroom of the appliance manufacturer, for example, General Electric®. The home purchaser can then visit the showroom and present the voucher and also present certain additional funds they may wish to contribute to upgrade to a larger refrigerator or a more expensive dishwasher. It is noted in the present embodiment that a builder may be any entity that facilitates in part, or as a whole, the construction of the new building, as well as a sub-contractor or supplier of any product or service associated with the construction of the new building.

Continuing, the purchaser may contact the builder to construct a new building on a parcel of land, of which the building may be a house. Accordingly, the specifications for constructing the building may be mandated by the purchaser, offered as standard by the builder, or be any combination thereof. As previously mentioned, a need exists for the purchaser to acquire outdoor equipment to maintain, protect, monitor, or otherwise keep up the land and/or the new building. The builder may propose that the purchaser purchase, in conjunction with the building and/or the land, outdoor equipment to maintain the property and that the outdoor equipment be purchased and financed together with building. In other words, the builder would quote a price for the construction of the building and include in that an additional amount for the purchase of a riding mower, for example. The type and variety of outdoor equipment may vary with the size of the property. In this manner, the builder may offer equipment package deals to the purchaser for an additional price along with the construction of a house. This may include groups of outdoor equipment oriented toward the type of outdoor upkeep the purchaser is interested in.

For example, the builder may offer a basic package consisting of a walk-behind mower and a snow blower at a nominal charge. Alternately, a gardening package may be offered wherein a riding mower, a trimmer, a tiller, a spreader, and a snow thrower are included for an incremental amount. Still another package may be added that includes path lighting, spotlights, and outdoor motion sensors. It is noted that some builders, as an incentive to the purchaser, may incorporate this without an additional charge. The purchaser may choose to trade in the basic package and upgrade to additional and heavier grade equipment as exemplified by the description of the gardening package. In any event, the builder offers, along with the construction or sale of a property, outdoor equipment for use in maintaining the property. This may include vouchers for use at the supplier's distribution center for selecting pre-specified equipment models or for a pre-specified dollar amount. The purchaser may then proceed to a lending entity in a manner as described in the previous embodiment.

It is contemplated in an alternate embodiment that instead of the builder, a real estate agent or real estate company may offer outdoor equipment for sale in conjunction with the purchase of a property. In this embodiment, the property being purchased may include land and a building, which may be a house that has been constructed prior to any interest in purchasing the property by the purchaser. However, it is noted that it is not necessary that a house or building be present on the e property, only that the property require outdoor equipment for maintaining the property. In this manner, the real estate agent may offer for sale with the property, equipment vouchers for use in purchasing any desired equipment up to the value of the voucher. The purchaser would select a value amount for the equipment voucher and apply for a loan from a lending entity, in a manner described in the previous paragraphs, for the purchase of the property and the equipment voucher. The purchaser would then proceed to the supplier or the supplier's distribution center to select and purchase the desired outdoor equipment. Alternately, the real estate agent may offer pre-specified outdoor equipment packages for an additional cost, in which the additional cost would be included in the purchase price of the property. The purchaser may have a choice between several options, each of which would include equipment tailored to suit the needs of the purchaser and the property the purchaser desires to purchase. The purchaser would similarly apply for a loan from a lending entity, wherein upon approval the real estate agent would contact the supplier and facilitate the purchase and delivery of the equipment to the property at the appropriate time.

It is expressly noted that the method of the present invention may include the collaboration of any or all of the parties including the supplier, the builder, the lending entity, and the real estate agent in any manner chosen with sound judgment as is appropriate for selling and the financing of outdoor equipment with the construction, purchase, and/or financing of real estate.

The invention has been described with reference to at least one embodiment. Obviously, modifications and alterations will occur to others upon a reading and understanding of this specification. It is intended to include all such modifications and alternations in so far as they come within the scope of the appended claims or the equivalence thereof.

I/we claim:

1. A method of financing the purchase of outdoor power equipment in conjunction with the purchase and financing of an associated piece of real estate, the method comprising the steps of:
providing a mortgage loan amount for the associated piece of real estate;
providing at least a first associated item of outdoor equipment, the item having an associated purchase price; and,
including the associated purchase price of the at least a first associated item of outdoor equipment in the mortgage loan amount.

2. The method of claim 1, wherein the method further comprises the steps of:
providing an associated lending entity to provide the mortgage loan amount; and,
providing an associated supplier of the at least a first associated item of outdoor equipment.

3. The method of claim 2, wherein providing at least a first associated item of outdoor equipment, the item having an associated purchase price further comprises the step of:
providing at least a first associated item of outdoor power equipment, the item having an associated purchase price.

4. The method of claim 2, wherein the mortgage loan amount has an associated interest rate.

5. The method of claim 4, wherein the associated supplier and the associated lender entity are separate entities.

6. The method of claim 5, wherein the method further comprises the step of:
applying a mortgage lien to the associated first item of outdoor equipment.

7. The method of claim 1, wherein the method further comprises the steps of:
providing a lending entity to provide the mortgage loan amount; and,
providing a supplier of the outdoor power equipment, the lending entity receiving a commission from the supplier based upon the sale of the outdoor power equipment.

8. The method of claim 1, wherein the method further comprises the steps of:
providing a lending entity to provide the mortgage loan amount; and,
providing a supplier of the outdoor power equipment, the supplier receiving a commission from the lending entity based upon the recommendation by the supplier that an associated purchase utilize the lending entity for the mortgage loan.

9. The method of claim 2, wherein the method further comprises the step of:
providing a package deal, wherein the associated real estate and the associated outdoor equipment come together as a package.

10. A method of selling associated outdoor equipment for use in maintaining an associated item of real estate, the method comprising the steps of:
providing a an associated item of real estate;
providing at least a first item of outdoor equipment for use in maintaining the associated item of real estate;
providing a mortgage loan for the purchase of the associated item real estate and the at least a first item of outdoor equipment; and,
providing a voucher for use in purchasing the at least a first item of outdoor equipment.

11. The method of claim 10, wherein the method further comprises the step of:
providing a supplier to supply the at least a fist item of outdoor equipment, the supplier accepting the voucher for purchase of the at least a first item of outdoor equipment.

12. The method of claim 11, wherein the method further comprises the step of:
applying a mortgage lien to the associated at least a first item of outdoor equipment.

13. The method of claim 12, wherein the associated at least a first item of outdoor equipment is chosen from the group comprising: fertilizer spreaders, outdoor lighting, motion sensors, power tools, power blowers, air sweepers for lawn debris, power operated, tractor-towed impellers, lifts, tillers, cultivators, plows, vacuums, blowers, lawn sweepers, mulchers, riding mowers, walk-behind mowers, self-propelled mowers, side discharged mowers, convertible lawn mowers, rear discharge mowers, side-discharge high-wheel mowers, mulching mowers, electric mowers, chipper/shredders, front tine tillers, rear tine tillers, self-propelled tillers, edgers, snow throwers, track driver snow throwers, log splitters, commercial lawn mowers, riding sulkies, seated sulkies for lawn mowers, multi-purpose vacuum cleaners, lawn and garden tractors, and three-point tractor hitches.

14. The method of claim 12, wherein the method further comprises the step of:
providing a building contractor to facilitate the construction of the real estate property.

15 The method of claim 14, wherein the method further comprises the steps of:
wherein a percentage rate of the loan f to purchase the real estate is the same percentage rate of the loan for lending money to purchase the outdoor equipment; and,
wherein the terms of the loan for the real estate is the same as the terms for the outdoor equipment.

16. The method of claim 10, wherein the method further comprises the steps of:
providing a lending entity to provide the mortgage loan amount; and,
providing a supplier of the outdoor power equipment, the lending entity receiving a commission from the supplier based upon the sale of the outdoor power equipment.

17. The method of claim 10, wherein the method further comprises the steps of:
providing a lending entity to provide the mortgage loan amount; and,
providing a supplier of the outdoor power equipment, the supplier receiving a commission from the lending entity based upon the recommendation by the supplier that an associated purchase utilize the lending entity for the mortgage loan.

18. A computer readable medium containing instructions for controlling a computer system to perform a method, the method comprising:
providing a mortgage loan amount for the associated piece of real estate;
providing at least a first associated item of outdoor equipment, the item having an associated purchase price; and,
including the associated purchase price of the at least a first associated item of outdoor equipment in the mortgage loan amount.

19. The computer readable medium of claim 18, wherein the method further comprises the steps of:
providing an associated lending entity to provide the mortgage loan amount; and,
providing an associated supplier of the at least a first associated item of outdoor equipment.

20. The computer readable medium of claim 19, wherein providing at least a first associated item of outdoor equipment, the item having an associated purchase price further comprises the step of:
providing at least a first associated item of outdoor power equipment, the item having an associated purchase price.

21. The computer readable medium of claim 19, wherein the mortgage loan amount has an associated interest rate.

22. The computer readable medium of claim 21, wherein the associated supplier and the associated lender entity are separate entities.

23. The computer readable medium of claim 22, wherein the method further comprises the step of:
applying a mortgage lien to the associated first item of outdoor equipment.

24. The computer readable medium of claim 18, wherein the method further comprises the steps of:
providing a lending entity to provide the mortgage loan amount; and,
providing a supplier of the outdoor power equipment, the lending entity receiving a commission from the supplier based upon the sale of the outdoor power equipment.

25. The computer readable medium of claim 18, wherein the method further comprises the steps of:
providing a lending entity to provide the mortgage loan amount; and,
providing a supplier of the outdoor power equipment, the supplier receiving a commission from the lending entity based upon the recommendation by the supplier that an associated purchase utilize the lending entity for the mortgage loan.
